(19) United States
(12) Patent Application Publication
(10) Pub. No.: US 2002/0005766 A1
(43) Pub. Date: Jan. 17, 2002

(54) RF resonator

(76) Inventors: Farhat Abbas, Twickenham (GB); Ran-Hong Yan, Farington (GB)

Correspondence Address: Docket Administrator, Lucent Technologies Inc., 101 Crawfords Corner Road (Room 3J-219), P.O. Box 3030, Holmdel, NJ, 07733-3030, US

(21) Appl. No.: 09/825,119

(22) Filed: Apr. 3, 2001

(30) Foreign Application Priority Data
Apr. 7, 2000 (EP) 00302941.0

(51) Int. Cl. H01P 7/00

(52) U.S. Cl. 333/99 S; 505/210; 333/219

(57) ABSTRACT

In order to provide a resonator for rf, especially microwave frequencies, for use in mobile telecommunications systems and satellite communications systems, with a particularly high Q value, the resonator, of predetermined width (Y) and thickness (X), and having a predetermined length (Z) in the direction of propagation for achieving a desired resonance, comprises a dielectric substrate, and first and second dielectric layers on two opposite faces of the substrate forming mirrors at which electromagnetic waves propagating along the length of the substrate will experience internal reflection, the dielectric layers having a predetermined thickness and having a dielectric constant less than that of the substrate. First and second conductive layers are formed on the outer surfaces of the dielectric mirrors. The substrate may be formed of sapphire and the dielectric mirrors of MgO. The conductive layers may be normal conductors or superconducting HTS layers.

### CROSS-REFERENCE TO RELATED APPLICATIONS

This application claims priority of European Patent Application No. 00302941.0, which was filed on Apr. 7, 2000.

Related subject matter is disclosed in the following application assigned to the same assignee hereof: U.S. Patent application entitled “Frequency Stable Resonator,” Serial No. _________, filed __________.

### BACKGROUND OF THE INVENTION

1. Field of the Invention

The present invention relates to a resonator for radio frequencies (rf), especially microwave frequencies, for use in circuits such as filters in systems such as mobile telecommunications systems, satellite communications systems, etc.

2. Description of the Related Art

Resonator devices are well known in microwave circuits for providing a resonant frequency, since the usual inductor/capacitor resonant circuit cannot easily be implemented at microwave frequencies. A resonator may be formed from a short length of transmission line, for example quarter-wave or half-wavelength. Resonators may be formed as cavity resonators formed from a variety of hollow structures such as rectangular cavities. Dielectric resonators consist of a ceramic resonator with a high dielectric constant and are usually cylindrical in shape.

For transmission line resonators, they may be implemented in any of the known technologies for microwave circuits, such as integrated circuits, strip line, in which two opposing dielectric layers have a central conductor disposed between them and groundplane conductors on the outer sides of the dielectric, or microstrip having a single dielectric layer having on one side a metallic groundplane and on the other side one or more strip conductors.

It is desirable that a resonator should have a high Q value, which is normally measured as the centre frequency of the resonance relative to width of resonance at the—3 dB value. It has previously been proposed to enhance the Q value by employing active circuits which provide a negative resistance, see for example: Romano A; Mansour R. R; “Enhanced-Q Microstrip Bandpass Filter with coupled Negative Resistors”, IEEE MTT-S, pp. 709-712, 1997.

It has previously been proposed to use superconducting films as parallel-plate transmission lines, see:

[1] Abbas F; and Davis L E; “Propagation coefficient in a superconducting asymmetric parallel-plate transmission line with buffer layer”, J. Appl. Phys. vol. 73, pp. 4494-4499, 1993.

[2] Abbas F; et al “Field solution for a thin-film superconducting parallel-plate transmission line”, Physica C, vol. 215, pp. 132-144, 1993.

[3] M Manzel; et al “TBCOO-films for passive microwave devices”, 22^{nd} European Microwave Conf; Helsinki Uni. Tech. Espoo, Finland, pp 81-86, 28 August 1992.

[4] E C Jordan and K G Balmain, Electromagnetic waves and Radiating Systems, 2^{nd} edn (Englewood Cliffs, N.J.: Prentice-Hall) pp 273, 1968.

[5] Abbas F; and Davis L E; “Radiation Q-Factor of high-Tc superconducting parallel-plate resonators” IEE Electron. Lett. vol. 29, pp. 105-107, 1993.

### SUMMARY OF THE INVENTION

The present invention provides a new and improved resonator structure for microwave and other frequencies.

The present invention is based on the following combination of features:

1. A dielectric substrate of predetermined width and thickness, and length in the direction of propagation of the electromagnetic wave, λ/2 or λ/4, or thereabouts allowing for correction factors. Where the resonator is incorporated in an integrated circuit, the substrate will be part of the IC substrate.

2. First and second parallel dielectric layers on two opposite faces of the substrate and extending along the length of the substrate to form mirrors at which the microwaves propagating in the substrate will experience internal reflection. The prime requirement for this is that the dielectric constant of the mirrors should be less than that of the substrate.

In addition, the layers will have a predetermined thickness which will be a compromise between the desirability of keeping width as small as possible for miniaturization and the need for enhancing the Q value.

3. First and second conductive layers, normally conducting or superconducting (HTS), overlying the first and second dielectric layers and forming a shield or seal to enclose the radiation within the resonator. In accordance with the invention it has been realised that where the internal reflection described above is total or at least the greater part of radiation is reflected, then in certain circumstances, these first and second conductive layers may be dispensed with, since there is such a small amount of radiation impinging on the conductive layers that they become superfluous.

Thus, the present invention provides an electromagnetic resonator comprising a dielectric substrate of predetermined width and thickness, and having a predetermined length in the direction of propagation for achieving a desired resonance; and first and second dielectric layers on two opposite faces of the substrate and extending along the length of the substrate to form mirrors at which electromagnetic waves propagating along the length of the substrate will experience internal reflection, the dielectric layers having a predetermined thickness and having a dielectric constant less than that of the substrate.

As preferred, first and second conductive layers, normally conducting or superconducting (HTS), overly the first and second dielectric layers and forming a shield or seal to enclose the radiation within the resonator.

A resonator according to the invention incorporating the above features may have a particularly high Q value and may be used in microwave frequency applications, or other rf frequencies, for example UHF or VHF. High Q dielectric loaded normal or superconducting resonators in accordance with the invention have many potential microwave applications, for example in satellite and mobile communications, secondary frequency standards and satellite navigation.

For low-phase noise performance the Q value of the resonator should be as high as possible. The contribution to the Q value arising from the normal or superconductors and the individual dielectric components is determined from parameters of the resonator structure. Where the resonator is incorporated in a filter, for example for mobile communications, transmission and reflection response of the filter is optimized by the Q-enhancement due to the internal reflection at the surfaces of the dielectrics of the resonator.

### BRIEF DESCRIPTION OF THE DRAWINGS

A preferred embodiment will now be described with reference to the accompanying drawings wherein:

FIG. 1 is a schematic sectional view of a resonator according to the invention;

FIG. 2 is a graph of quality factor Q versus thickness of dielectric mirrors for the structure of FIG. 1;

FIG. 3 is a schematic diagram of a resonator according to the invention incorporated in a filter structure; and

FIGS. 4 and 5 are graphs showing fourth-order Butterworth and fourth-order Chebyshev bandpass filters employing resonators according to the invention.

### DESCRIPTION OF THE PREFERRED EMBODIMENT

In comparison to microwave monolithic integrated circuits (MMICs) microwave filters are quite bulky. To reduce the mass and size of communications, radar, and signal processing systems, MMICs have made it possible to significantly reduce the size of amplifiers, and other non-filtering circuits, without performance degradation. Passive filters are generally not possible to miniaturize without a trade-off in performance. Microstrip or lumped-elements filters are smaller, but always result in low performance, for a given filter order. The best isolation-to-size ratio can be obtained from SAW filters but they are extremely lossy, and cannot operate with high powers.

In accordance with the invention, resonators employing high temperature superconducting (HTS) technology can be used in filters to reduce the filter size without degrading performance. The invention provides a planar microwave multi layer dielectric resonator for a high performance filter for mobile communications, which can be miniaturized sufficiently small for incorporation in an integrated circuit.

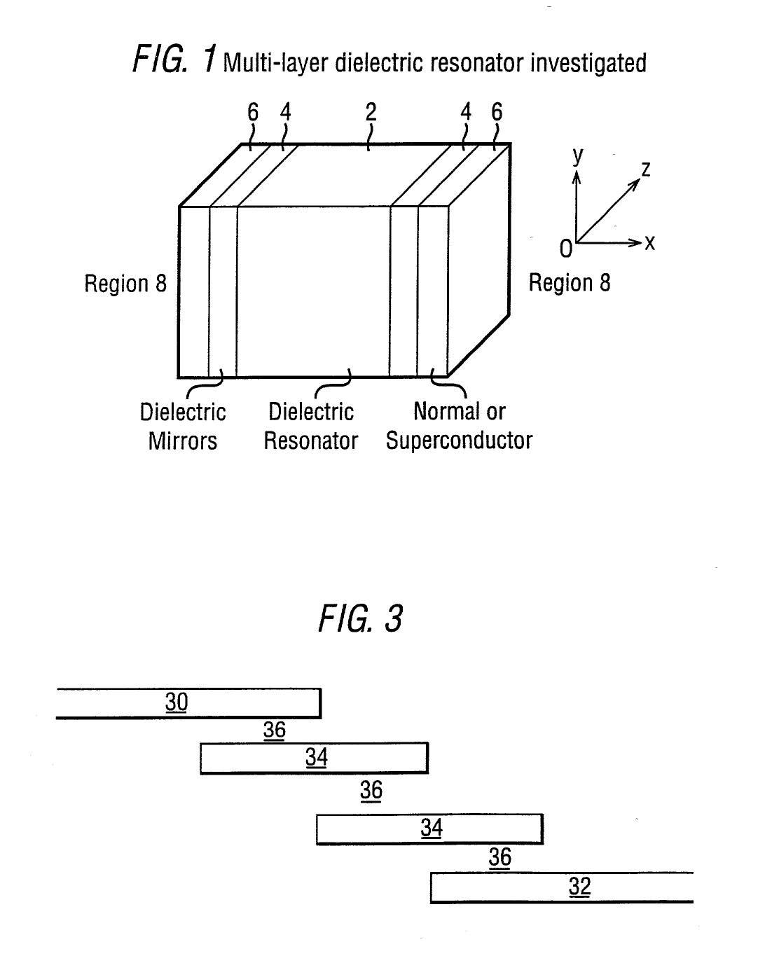

Referring to FIG. 1, a rectangular dielectric resonator has a width Y a thickness or depth X and a length Z, in the direction of propagation of electromagnetic waves. The length Z is a predetermined value, for example λ/2 or λ/4, to achieve a desired resonance. The resonator comprises a central dielectric substrate 2 having a thickness d₂ of a material such as sapphire. On opposite faces of the substrate 2 are formed dielectric mirrors 4, for example of magnesium oxide (MgO) of a predetermined thickness d₁, in the range 1 to 100 nm. On the outer faces of dielectric mirrors 4 are formed conductive layers 6 having a thickness 1. These conductors may be formed of a normal conductor, for example copper, or a superconductor, for example an HTS structure such as YBCO. The thickness of such layers or films 6 is of the order of hundreds of nm, for example 140 nm (the minimum thickness of the films should be at least five times the penetration depth of the radiation). The dielectric constant of the mirror layers 4 is less than that of the substrate 2 in order to confine the field within the substrate by internal reflection at the inner surfaces of the dielectric mirrors. The materials of the substrate, dielectric mirrors, and conductive layers may be of any suitable type for the particular implementation of the resonator in view. This is subject however, to the constraint that the dielectric constant of the mirrors is less than that of the substrate. Other materials for the mirrors 4 are , e.g., teflon or duriod.

The mathematical analysis of the resonator of FIG. 1 is as follows. The dielectric region 8 outside the conductor layers 6 is assumed to be very thick so that the fields in these regions can be assumed to exponentially decay away from the interfaces. Consider the propagation of an electromagnetic wave in the z-direction of the resonator shown in FIG. 1. It is assumed that the dielectric thicknesses (d₁ and d₂) and the penetration depth λ of the high temperature superconductors are very small compared to the dimension in the Y direction of the resonator, which in turn is very small compared to the length of the resonator.

From FIG. 1, and the above assumptions, it is clear that the edge effects can be neglected, and there is no y-dependence of the fields and currents. The two-fluid model is used for the superconductors, in which the total current is the sum of the supercurrent and the normal current. Classical skin effect and London theory are assumed for the normal current and the supercurrent, respectively. Considering a TM wave:

$$\begin{matrix}\overline{{H}_{y}} = \frac{1}{{αμ}_{o} ω} ( {α}^{2} - {κ}^{2} ) \overline{{E}_{x}} , & \overline{{E}_{z}} = \frac{i}{α} \frac{ⅆ \overline{{E}_{x}}}{ⅆ x} , \\ \frac{{ⅆ}^{2} \overline{{E}_{x}}}{ⅆ {x}^{2}} - {κ}^{2} \overline{{E}_{x}} = 0 , & \end{matrix} \qquad ( 1 )$$

where, for the dielectrics:

$${κ}^{2} \underline{\underline{Δ}} {K}_{r}^{2} = {α}^{2} - {ω}^{2} {ϵ}_{r} {μ}_{o} , r = 1 , 2 , 3 , \qquad ( 2 )$$

while for the superconductors:

$${κ}^{2} \underline{\underline{Δ}} {κ}^{2} = \frac{1}{{λ}^{2}} + {α}^{2} - {ω}^{2} {ϵ}_{o} {μ}_{o} + i {ωμ}_{o} σ , \qquad ( 3 )$$

also for the normal conductors:

$${κ}^{2} \underline{\underline{Δ}} {κ}^{2} = {α}^{2} - {ω}^{2} {ϵ}_{o} {μ}_{o} + i {ωμ}_{o} σ . \qquad ( 4 )$$

Here, κ is the total propagation constant, α is the propagation constant along the z direction (taking e^{tαz}), ω is the angular frequency (assuming e^{tωt}), ε₀ and μ₀ are the permittivity and the permeability of vacuum respectively, εᵣ is the dielectric constant of the dielectrics, λ and σ are the penetration depth and the conductivity of the superconductors, respectively. Equation (1) is a second-order differential equation which has two independent solutions of the form e^{kx} and e^{-kx}, where κ is taken to be the root of κ² with positive real part. In the positive x-direction of the dielectric, beyond the conductive layers 6, we take only the solution e^{K}₃^{x}, and in the negative x-direction we take only the solution e^{K}₃^{x}, discarding e^{K}₃^{x} for positive x-direction, and e^{-K}₃^{x} for negative x-direction. In the normal conductors or superconductors, the dielectric mirrors 4 and in the substrate 2 both solutions are retained in order to satisfy the boundary conditions.

With these solutions in the various media, we have twelve arbitrary constants for the amplitudes of the fields (one each in the dielectrics, beyond the layers 6, two each in the layers 6, the dielectric mirrors 4 and the substrate 2. There are twelve boundary conditions that must be satisfied, namely the continuity of the tangential fields \overline{E}_{z} and \overline{H}_{y} at the six boundaries shown in FIG. 1. If we ignore any non-linearity in the system, the characteristics of the resonator are independent of the amplitude of the wave, and eleven of the constants can be determined in terms of the twelfth by using eleven of the twelve boundary conditions. The twelfth boundary condition gives an equation for the propagation constant α, which must be satisfied in order for a solution to exist.

The condition is a transcendental equation for which an exact solution cannot be readily obtained. Approximating K₁d₁<<1 and K₂d₂<<1 (where K₁ and K₂ are the respective propagation constants of respective layers 4 and substrate 2) and physically these approximations mean that higher order modes are ignored. With small d₁ and d₂, higher order modes will not be excited. With these assumptions, the transcendental equation yields:

$${α}^{2} = \frac{{ω}^{2} {μ}_{o} {ϵ}_{o} {ϵ}_{1} {ϵ}_{2}}{( 2 {d}_{1} {ϵ}_{2} + {d}_{2} {ϵ}_{1} )} [ 2 λcoth ( \frac{l}{λ} ) + 2 {d}_{1} + {d}_{2} ] \qquad ( 5 )$$

In equation (5), the subscript ₀ refers to the conductor layers 6, the subscript ₁ refers to the mirror layers 4, the subscript ₂ refers to the substrate, and λ refers to the penetration depth in superconductor layers 6.

For normal conductor layers, such as copper, the penetration depth λ should be replaced by the factor

$$\sqrt{\frac{1}{{λ}^{2}} + i {ωμ}_{0} {σ}_{r}} , with \frac{1}{λ} = 0.$$

The wave velocity relative to that in a vacuum can be written as follows from equation (5):

$${V}_{r} = \sqrt{\frac{( 2 {d}_{1} {ϵ}_{2} + {d}_{2} {ϵ}_{1} )}{{ϵ}_{1} {ϵ}_{2} [ 2 λcoth ( l / λ ) + 2 {d}_{1} + {d}_{2} ]}} . \qquad ( 6 )$$

According to equation (6), the wave is dispersionless even though there is a component of the electric field in the direction of propagation, i.e., the group velocity and phase velocity are equal and independent of frequency. The attenuation of the wave due to losses in each medium and the wave velocity can be obtained by replacing ε₁, ε₂ and λ into their complex forms (the imaginary part giving loss and the real part giving phase).

From the above considerations, it is possible, in accordance with the invention, to appreciate the quality factor Q of resonators in accordance with the invention. The loaded quality factor Q₁ of a transmission resonator is evaluated from the measured resonant curve by dividing the resonant frequency f₀ by the 3-dB width, ∇f, of the resonant curve. The unloaded quality factor Q₀ can be calculated from the insertion loss of the resonator at resonant frequency:

$${Q}_{o} = \frac{{Q}_{1}}{1 - \vert {S}_{12} \vert} \qquad ( 7 )$$

here

$${S}_{12} \vert \underline{\underline{Δ}} \sqrt{{P}_{1} / {P}_{j}} .$$

With the resonator of the invention, four kinds of Q-factor may be obtained due to losses in conductors 6,Q_{c}, losses in mirror layers 4,Q_{d1}, losses in substrate 2, Q_{d2}, and radiation losses from the four open sides of the resonator as shown in FIG. 1, Qᵣ. The total Q-factor of the resonator can be written in terms of Q_{c}, Q_{d1}, Q_{d2} and Qᵣ as follows:

$$\frac{1}{{Q}_{o}} = \frac{1}{{Q}_{c}} + \frac{1}{{Q}_{d1}} + \frac{1}{{Q}_{d2}} + \frac{1}{{Q}_{r}} \qquad ( 8 )$$

where Q₀ is the total Q-factor of the resonator and is same as in the equation (7). Q_{c}, Q_{d1}, Q_{d2} can be written as follows:

$$\begin{matrix}{Q}_{c} = \frac{ω}{2 {α}_{c} {υ}_{g}} & ( 9 ) \\ {Q}_{d1} = \frac{ω}{2 {α}_{d1} {υ}_{g}} & ( 10 ) \\ {Q}_{d2} = \frac{ω}{2 {α}_{d2} {υ}_{g}} & ( 11 ) \\ {υ}_{g} = \frac{{υ}_{2}^{2}}{{υ}_{p}} & ( 12 ) \\ {υ}_{2} {Δ}_{\underline{\_}} [ {ℜ ( {ϵ}_{2} {μ}_{o} 0 ]}^{- 1 / 2} & ( 13 )\end{matrix}$$

where α is the z-direction propagation constant in the corresponding material, v_{g} is the group velocity in the corresponding material, v₂ is the velocity in the substrate 2 for an unbounded substrate, and vp is the phase velocity in the corresponding material.

In accordance with the invention, the above equations (8)-(13) indicate that conductor losses, and the factor Q_{c}, may be the main influence on broadening the Q value and should be minimised. Consider superconductors 6 are thin films of YBCO, and mirrors 4 and substrate 2 are MgO and sapphire, respectively, and the value for penetration depth for the high quality thin films of YBCO is 140 nm. The normal conductivity for thin films is assumed to be 1.7×10⁶ (ohms.m)⁻¹. The thicknesses of the thin films are assumed to be 700 nm (approximately five penetration depths) and operating frequency and operating temperature are 10 GHz, T/Tc=0.5.

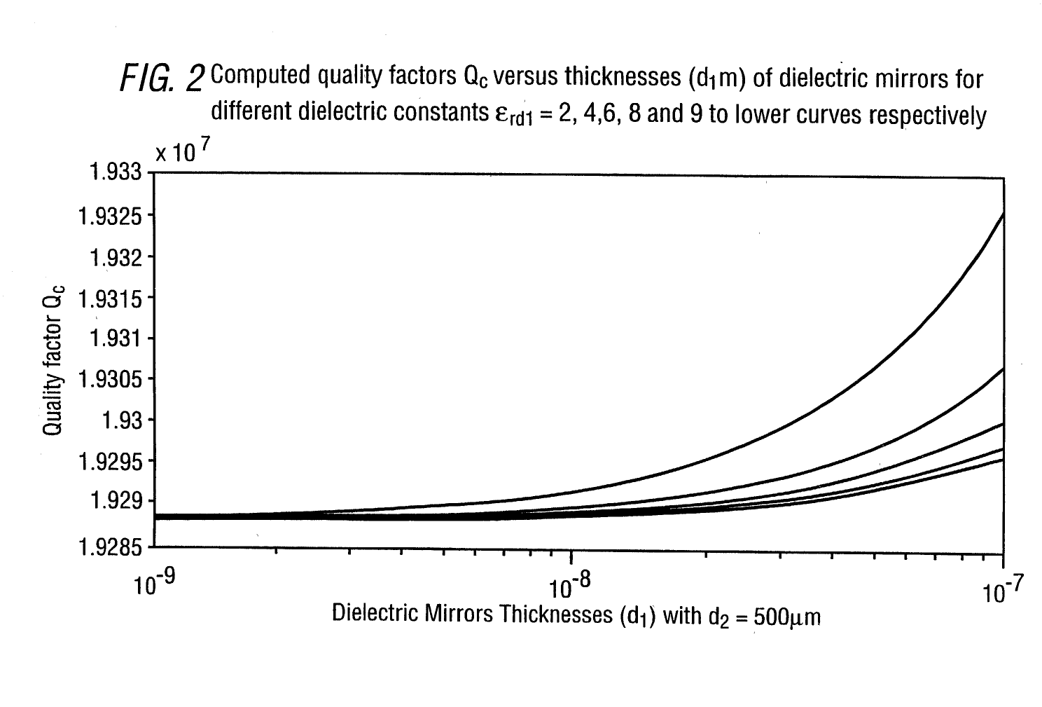

In FIG. 2 the values of quality-factor Q_{c} for the superconductor layers 6 are plotted as a function of mirror thickness (d₁-values given in meters), the thickness of the sapphire substrate 2 being 500 μm, and T/T_{c}=0.5. The resonator is assumed to be sapphire with ε_{rd2}=10 and tanδ₂=0. The dielectric mirrors are assumed to be MgO with ε_{rd1}=2, 4, 6, 8 and 9 and tanε₁=0. The values of Q_{c} are increased as the mirror thickness is increased as shown in FIG. 2. This implies that less radiation is reaching the conductive layers 6 to create losses with thicker mirror layers 4. Also, it is interesting to see that the values of Q_{c} are increased if the dielectric constant of dielectric mirrors is decreased. This is due to increased internal reflection between sapphire and dielectric mirrors, for decreasing values of dielectric constant of the dielectric mirrors. As the dielectric constant of the dielectric mirrors decreases the internal reflection at the dielectric interface increases, the field at the normal or superconductor surface is decreased, and hence the Q_{c} values are increased. This also implies reduced radiation through the films which increases the Qᵣ.

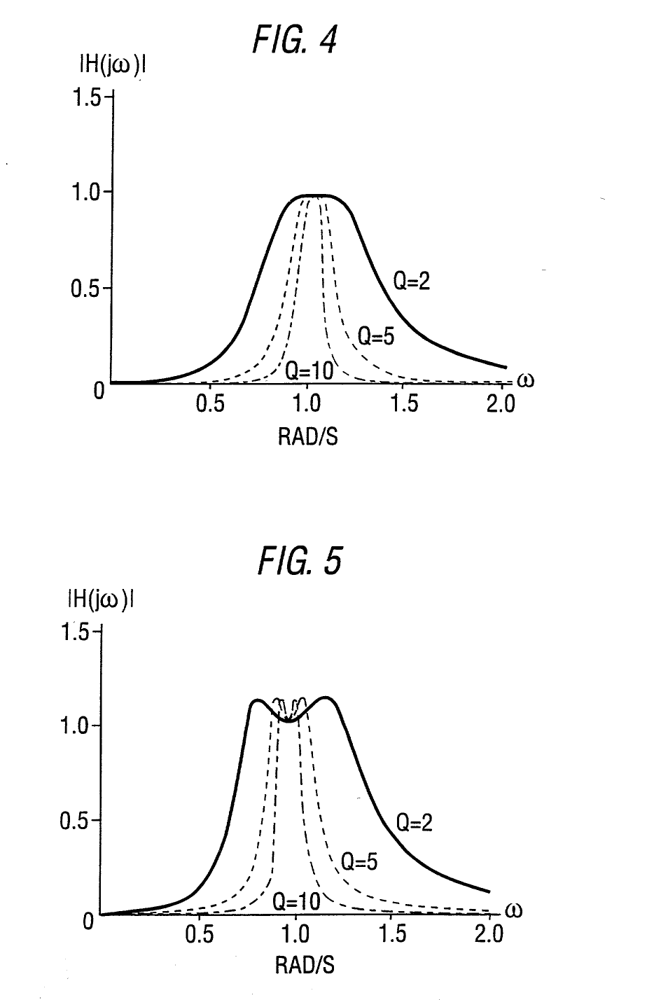

Referring to FIG. 3 there is shown a schematic implementation of a miniaturised passive filter for rf frequencies which may be implemented for example, in microstrip or on an integrated circuit. The filter comprises an input line 30 coupled to an output line 32 via intervening resonator elements 34 of constant length and width, each resonator element being constructed as shown in FIG. 1. The parameters of the filter are varied by adjusting the spacings 36 between the elements so as to adjust the electromagnetic coupling factors. FIGS. 4 and 5 examples of fourth-order Butterworth and fourth-order Chebyshev bandpass amplitudes are shown, for ω₀=1 rad/s and various values of Q. It is clear from these results that higher Q corresponds to narrower passbands.

There has thus been shown and described a resonator device, primarily for microwave applications, although it can be used at any radio frequency. It has particular application in wireless mobile telecommunication substrates, for example in a BTS which may have numerous filters and oscillators operating in the VHF range. Proposed herein is a new class of planar microwave narrow bandpass filter using multi layers of rectangular dielectric for Q-enhancement.

1. An electromagnetic resonator of predetermined width (Y) and thickness (X), and having a predetermined length (Z) in the direction of propagation for achieving a desired resonance comprising a dielectric substrate of predetermined thickness; first and second dielectric layers on two opposite faces of the substrate and extending along the length of the substrate to form mirrors at which electromagnetic waves propagating along the length of the substrate will experience internal reflection, the dielectric layers having a predetermined thickness and having a dielectric constant less than that of the substrate.

2. The resonator of claim 1, including first and second conductive layers (6) formed on the outer surfaces of the first and second dielectric layers of a predetermined thickness.

3. The resonator of claim 2, wherein the conductive layers are formed of a normal conductor, for example copper.

4. The resonator of claim 2, wherein the conductive layers are formed of a high temperature superconductor, for example YBCO.

5. The resonator of claim 2, wherein the thickness of the conductive layers is at least five penetration depths of the electromagnetic field.

6. The resonator of claim 1, wherein the dielectric constant of the substrate is 10 or more, and the dielectric constant of the mirror layers is less than 10.

7. The resonator of claim 6, wherein the substrate is formed of sapphire and the dielectric mirrors are formed of magnesium oxide.

8. The resonator of claim 1, wherein the thickness of the dielectric mirrors is between 10⁻⁹ and 10 ⁻⁷ meters

9. The resonator of claim 8, wherein the thickness of the dielectric mirrors is greater than 10⁻⁸ meters.

10. The resonator of claim 8, wherein the dielectric constant of the dielectric mirrors is less than half that of the substrate.

11. The resonator of claim 2, wherein the electromagnetic field propagates in the zeroth mode without substantial high order modes, and wherein the quality factor Q of the resonator is made up as follows:
$$\frac{1}{{Q}_{o}} = \frac{1}{{Q}_{c}} + \frac{1}{{Q}_{d1}} + \frac{1}{{Q}_{d2}} + \frac{1}{{Q}_{r}}$$
Q₀ is the total Q-factor and Q_{c}, Q_{d1}, Q₂, Qᵣ are the components of the Q-factor due to the conductive layers, the dielectric mirror layers, the substrate and the external radiation respectively, and wherein the factor Q_{c} is as follows:
$${Q}_{c} = \frac{ω}{2 {α}_{c} {υ}_{g}}$$
where ω is the frequency of operation, α_{c} is the propagation constant in the conductor layers and v_{g} is the group velocity in the conductor layers, and wherein these factors are dependent on the thickness of the dielectric mirror layers and the relative parameters of the dielectric mirror layers and the substrate.

12. The resonator of claim 11, wherein the factor α_{c} is the real part of the following:
$${α}_{c}^{2} = \frac{{ω}^{2} {μ}_{o} {ϵ}_{o} {ϵ}_{1} {ϵ}_{2}}{( 2 {d}_{1} {ϵ}_{2} + {d}_{2} {ϵ}_{1} )} [ 2 λ coth ( \frac{l}{β} ) + 2 {d}_{1} + {d}_{2} ]$$
wherein ε₁ d₁, ε₂ d₂ are the values of dielectric constant and thickness for the substrate and temperature compensating layers, and wherein β is given by the expression
$$\sqrt{\frac{1}{{λ}^{2}} + i {ωμ}_{0} {σ}_{r} ,}$$
and λ is the penetration depth in the conductor.
